(19) United States
(12) Patent Application Publication
(10) Pub. No.: US 2017/0069409 A1
(43) Pub. Date: Mar. 9, 2017

(54) COAXIAL CABLE WITH OUTER CONDUCTOR ADHERED TO DIELECTRIC LAYER AND/OR JACKET

(71) Applicant: CommScope Technologies LLC, Hickory, NC (US)

(72) Inventor: Alan N. Moe, Hickory, NC (US)

(21) Appl. No.: 15/246,200

(22) Filed: Aug. 24, 2016

Related U.S. Application Data
(60) Provisional application No. 62/213,828, filed on Sep. 3, 2015.

(51) Int. Cl. H01B 11/18; H01B 7/02

(52) U.S. Cl. CPC H01B 11/1808; H01B 7/0216; H01B 7/0275

(57) ABSTRACT

A coaxial cable includes: an inner conductor; a dielectric layer surrounding the inner conductor; an outer conductor surrounding the dielectric layer and having a plurality of corrugations, wherein each of the corrugations has a root and a crest connected by a transition section; a jacket surrounding the outer conductor; and a first adhesive layer interposed between the dielectric layer and the roots of the corrugations of the outer conductor. Each of the roots has a curved flattened portion that is adhered to the first adhesive layer.

### RELATED APPLICATION

The present application claims priority from and the benefit of U.S. Provisional Patent Application No. 62/213,828, filed Sep. 3, 2016, the disclosure of which is hereby incorporated herein in its entirety.

### FIELD OF THE INVENTION

The present invention is directed generally to coaxial cable, and more particularly to outer conductors for coaxial cable.

### BACKGROUND

Coaxial cable typically includes an inner conductor, an outer conductor, a dielectric layer that separates the inner and outer conductors, and a jacket that surrounds the outer conductor. The outer conductor can take many forms, including flat, braided, and corrugated.

A typical corrugated cable outer conductor is manufactured by welding a thin wall cylindrical tube from a flat copper strip. This tube is then formed into a corrugated outer conductor with a specific shape by using use of one of several available forming methods. A typical shape for a corrugated cable is as shown in FIG. 1.

As can be seen in FIG. 1, the outer/major diameter, or crest 12, of the corrugations of the outer conductor 10 has a relatively gentle curvature (i.e., the radius RC is relatively large), whereas the inner/minor diameter, or root 14, of the corrugations has a relatively sharp curvature (i.e., the radius RR is relatively small). This shape is formed using a rotating spindle that carries a rotating tool that applies pressure to the welded thin-wall copper tube through a forming tool with circular cross section at the radius of the root 14 of the corrugation.

Because copper is costly and because the function of an outer conductor is primarily for shielding, a very thin copper (0.002″ thick) would perform the electrical shielding function adequately. However, the thickness of the outer conductor 10 is typically greater than 0.006″ due to manufacturing and mechanical limitations (particularly for welding of the seam).

While the illustrated corrugation shape is relatively easy to make and results in a cable with adequate bending performance, it may be desirable to further improve on the design and to further reduce the copper content of the cable, without further reduction of copper thickness at the weld zone, and also without sacrificing cable bending performance.

### SUMMARY

As a first aspect, embodiments of the invention are directed to a coaxial cable, comprising: an inner conductor; a dielectric layer surrounding the inner conductor; an outer conductor surrounding the dielectric layer and having a plurality of corrugations, wherein each of the corrugations has a root and a crest connected by a transition section; a jacket surrounding the outer conductor; and a first adhesive layer interposed between the dielectric layer and the roots of the corrugations of the outer conductor. Each of the roots has a curved flattened portion that is adhered to the first adhesive layer.

As a second aspect, embodiments of the invention are directed to a coaxial cable, comprising: an inner conductor; a dielectric layer surrounding the inner conductor; an outer conductor surrounding the dielectric layer and having a plurality of corrugations, wherein each of the corrugations has a root and a crest connected by a transition section; a jacket surrounding the outer conductor; a first adhesive layer interposed between the dielectric layer and the roots of the corrugations of the outer conductor; and a second adhesive layer interposed between the jacket and the crests of the corrugations of the outer conductor.

As a third aspect, embodiments of the invention are directed to a coaxial cable, comprising: an inner conductor; a dielectric layer surrounding the inner conductor; an outer conductor surrounding the dielectric layer and having a plurality of annular corrugations, wherein each of the corrugations has a root and a crest connected by a transition section; a jacket surrounding the outer conductor; and a first adhesive layer interposed between the dielectric layer and the roots of the corrugations of the outer conductor.

### BRIEF DESCRIPTION OF THE FIGURES

FIG. 1 is a side view of a portion of a corrugated outer conductor for a conventional coaxial cable.

FIG. 2 is an exploded side section view of a portion of a coaxial cable according to embodiments of the invention showing the jacket, the outer conductor, the dielectric layer, and two adhesive layers.

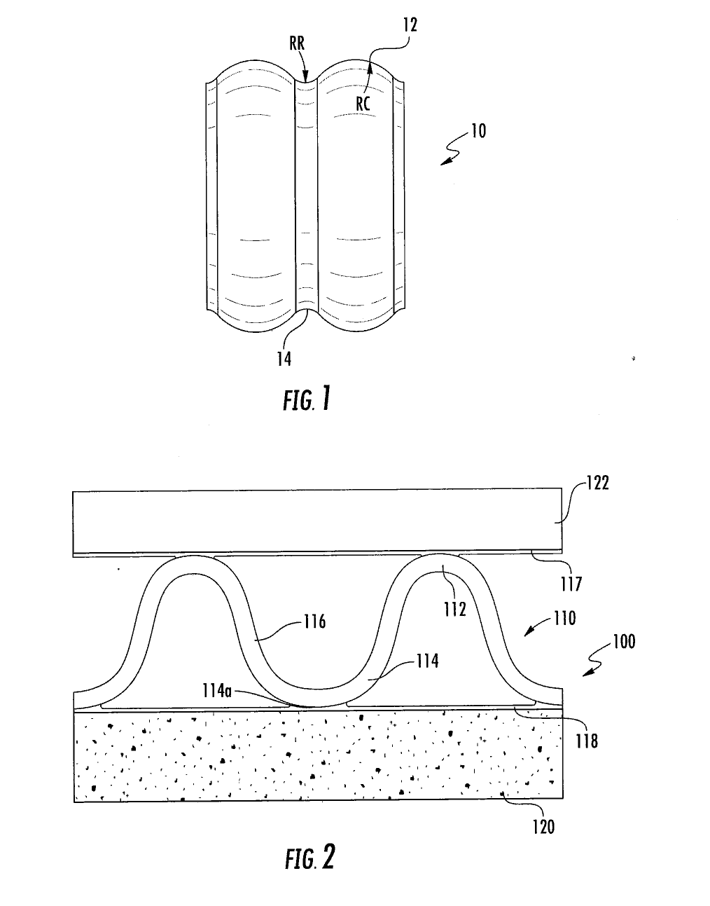

### DETAILED DESCRIPTION

The present invention is described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed herein can be combined in any way and/or combination to provide many additional embodiments.

Unless otherwise defined, all technical and scientific terms that are used in this disclosure have the same meaning as commonly understood by one of ordinary skill in the art to which this invention belongs. The terminology used in the above description is for the purpose of describing particular embodiments only and is not intended to be limiting of the invention. As used in this disclosure, the singular forms “a”, “an” and “the” are intended to include the plural forms as well, unless the context clearly indicates otherwise. It will also be understood that when an element (e.g., a device, circuit, etc.) is referred to as being “connected” or “coupled” to another element, it can be directly connected or coupled to the other element or intervening elements may be present. In contrast, when an element is referred to as being “directly connected” or “directly coupled” to another element, there are no intervening elements present.

The bending performance of a cable may be enhanced by creating an adhesive bond to the dielectric core and also to the jacket, using standard co-extrusion/heat bonding methods. This change assist the corrugated copper to better maintain its original shape during repeated bending, further enhancing the fatigue performance of the design by keeping a kinked area from developing and thereby keeping stresses from increasing rapidly and dramatically in the kinked area during repeated bending.

Referring now to FIG. 2, a portion of a cable, designated broadly at 100, is shown therein. The cable 100 includes an inner conductor (not shown), a dielectric layer 120 that surrounds the inner conductor, an outer conductor 110 that surrounds the dielectric layer 120, and a jacket 122 that surrounds the outer conductor 110. The outer conductor 110 comprises a plurality of corrugations, each of which includes a crest 112, a root 114, and a transition section 116 that merges with the crest 112 and root 114. In some instances, the corrugations are annular; in other embodiments, the corrugations may be helical.

In some embodiments, the radius of curvature of the root 114 may be equal to or greater than that of the crest 112. Such embodiments are described in co-assigned and co-pending U.S. Provisional Patent Application No. 62/213,367, filed Sep. 2, 2015 (Attorney Docket No, 9833-68PR), the disclosure of which is hereby incorporated herein in its entirety.

An adhesive layer 117 is interposed between the crest 112 and the jacket 122. Another adhesive layer 118 is interposed between the root 114 and the dielectric layer 120. The adhesive layers 117, 118 may be formed of a variety of different materials, including polyethylene, ethylene methacrylic acid, ethylene methyl acrylate, ethylene vinyl acrylate, styrene-isoprene-styrene, and styrene-ethylene-butylene-styrene. Either or both of the adhesive layers 117, 118 may be formed via co-extrusion during the application of the dielectric layer 120 and the jacket 122. Alternatively, a hot melt adhesive applicator may be used to apply the adhesive layer 118 over the dielectric layer 120.

The bonding of the root 114 of the outer conductor 110 may be helpful in suppressing the formation of kinks during reverse bending of the cable 100. Notably, the root 114 has a flattened bottom portion 114a to enhance the overall bonding area for reverse bending performance. The bonding of this flattened root area 114a may be especially helpful because it can support and reinforce the root area during bending, which is generally much weaker than the crest due its typically smaller area.

In some embodiments the crest 112 may also be flattened somewhat (although in some embodiments still generally arcuate or curved) to improve adhesion; however, because the jacket 122 may be pulled slightly down to conform over the crest 112 using a vacuum, and because the crest 112 is naturally stiffer due to its larger area, forming a flattened area spot on the corrugation crest 112 to enhance the bond may be less advantageous and therefore may be omitted in some embodiments.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A coaxial cable, comprising:
an inner conductor;
a dielectric layer surrounding the inner conductor;
an outer conductor surrounding the dielectric layer and having a plurality of corrugations, wherein each of the corrugations has a root and a crest connected by a transition section;
a jacket surrounding the outer conductor; and
a first adhesive layer interposed between the dielectric layer and the roots of the corrugations of the outer conductor;
wherein each of the roots has a curved flattened portion that is adhered to the first adhesive layer.

2. The coaxial cable defined in claim 1, further comprising a second adhesive layer interposed between the jacket and the crests of the corrugations of the outer conductor.

3. The coaxial cable defined in claim 1, wherein the root has a first radius of curvature, and the crest has a second radius of curvature that is less than the first radius of curvature.

4. The coaxial cable defined in claim 1, wherein the first adhesive layer is coextruded with the dielectric layer.

5. The coaxial cable defined in claim 1, wherein the first adhesive layer comprises polyethylene, ethylene methacrylic acid, ethylene methyl acrylate, ethylene vinyl acrylate, styrene-isoprene-styrene, and/or styrene-ethylene-butylene-styrene.

6. A coaxial cable, comprising:
an inner conductor;
a dielectric layer surrounding the inner conductor;
an outer conductor surrounding the dielectric layer and having a plurality of corrugations, wherein each of the corrugations has a root and a crest connected by a transition section;
a jacket surrounding the outer conductor;
a first adhesive layer interposed between the dielectric layer and the roots of the corrugations of the outer conductor; and
a second adhesive layer interposed between the jacket and the crests of the corrugations of the outer conductor.

7. The coaxial cable defined in claim 6, wherein the root has a first radius of curvature, and the crest has a second radius of curvature that is less than the first radius of curvature.

8. The coaxial cable defined in claim 6, wherein the first adhesive layer is coextruded with the jacket.

9. The coaxial cable defined in claim 7, wherein the first adhesive layer comprises polyethylene, ethylene methacrylic acid, ethylene methyl acrylate, ethylene vinyl acrylate, styrene-isoprene-styrene, and/or styrene-ethylene-butylene-styrene.

10. A coaxial cable, comprising:
an inner conductor;
a dielectric layer surrounding the inner conductor;
an outer conductor surrounding the dielectric layer and having a plurality of annular corrugations, wherein each of the corrugations has a root and a crest connected by a transition section;
a jacket surrounding the outer conductor; and
a first adhesive layer interposed between the dielectric layer and the roots of the corrugations of the outer conductor.

11. The coaxial cable defined in claim 10, further comprising a second adhesive layer interposed between the jacket and the crests of the corrugations of the outer conductor.

12. The coaxial cable defined in claim 10, wherein the root has a first radius of curvature, and the crest has a second radius of curvature that is less than the first radius of curvature.

13. The coaxial cable defined in claim 10, wherein the first adhesive layer is coextruded with the dielectric layer.

14. The coaxial cable defined in claim 10, wherein the first adhesive layer comprises polyethylene, ethylene methacrylic acid, ethylene methyl acrylate, ethylene vinyl acrylate, styrene-isoprene-styrene, and/or styrene-ethylene-butylene-styrene.
